(19) United States
(12) Patent Application Publication
(10) Pub. No.: US 2022/0187472 A1
(43) Pub. Date: Jun. 16, 2022

(54) RECORDING SYSTEM AND APPARATUS INCLUDING USER-DEFINED POLYGON GEOFENCING

(71) Applicant: INVISIBLE INTELLIGENCE, LLC, Augusta, ME (US)

(72) Inventors: Ronald Paul COTE, West Gardiner, ME (US); John Arthur GUIMOND, Fairfield, ME (US)

(21) Appl. No.: 16/995,744

(22) Filed: Aug. 17, 2020

Related U.S. Application Data
(63) Continuation-in-part of application No. 16/368,482, filed on Mar. 28, 2019, now Pat. No. 10,948,601.
Application No. 16/368,482 is a continuation of application No. 15/393,666, filed on Dec. 29, 2016, now Pat. No. 10,261,189.
Application No. 15/393,666 is a continuation-in-part of application No. 15/179,475, filed on Jun. 10, 2016, now abandoned.
Application No. 15/179,475 is a continuation of application No. 14/068,065, filed on Oct. 31, 2013, now Pat. No. 9,391,807.
(60) Provisional application No. 62/887,362, filed on Aug. 15, 2019.

(51) Int. Cl. G01S 19/03; H04L 67/1097; G06F 3/0482; G10L 15/26; G10L 19/018; G08G 5/00; H04L 12/64; G06F 3/16

(52) U.S. Cl. CPC G01S 19/03; H04L 67/1097; G06F 3/0482; G10L 15/26; H04L 67/10; G08G 5/0013; H04L 12/6418; G08G 5/0026; G06F 3/162; G10L 19/018

(57) ABSTRACT

A system and apparatus for recording and archiving diverse communications over radio transmissions. The system and apparatus enables unattended airports within a geofenced area to generate a useful archive of all radio communications made by Automatic Dependent Surveillance-Broadcast (ADS-B) equipped aircraft and ground personnel. A combination of hardware and software components are provided to record and store radio transmissions in computer files. Recording archiving and reporting of received and stored data includes aircraft identification, location and heading and other data, including time-based data within one or more user-defined polygons.

### RELATED APPLICATIONS

This is a continuation-in-part of U.S. patent application Ser. No. 16/368,482 filed on Mar. 28, 2019 entitled “RECORDING SYSTEM AND APPARATUS INCLUDING GEOFENCING”, which is a continuation of U.S. patent application Ser. No. 15/393,666 filed on Dec. 29, 2016, and which granted as U.S. Pat. No. 10,261,189 on Apr. 16, 2019 entitled “RECORDING SYSTEM AND APPARATUS INCLUDING GEOFENCING”, which is a continuation-in-part of U.S. patent application Ser. No. 15/179,475 filed on Jun. 10, 2016 entitled “AUDIO RECORDING SYSTEM AND APPARATUS”, which is a continuation of U.S. patent application Ser. No. 14/068,065 filed on Oct. 31, 2013, and which granted as U.S. Pat. No. 9,391,807 on Jul. 12, 2016 2016 entitled “AUDIO RECORDING SYSTEM AND APPARATUS”, which are hereby incorporated by reference in their entireties. The present application further claims the benefit of priority to U.S. Provisional Application 62/887,362 filed on Aug. 15, 2019 entitled “RECORDING SYSTEM AND APPARATUS INCLUDING POLYGON GEOFENCING”, which is incorporated by reference herein.

### FIELD OF THE INVENTION

The present invention relates generally to the management of data from the recording of radio transmissions and radio transmission data in a general aviation airport. More particularly, the present invention relates to systems and methods for recording, archiving, replaying and the displaying of operational statistics of radio transmissions from voice and aircraft data communications for systems planning and day-to-day management of an unattended airport.

### BACKGROUND OF THE INVENTION

In the area of communications involving multiple parties, there exist systems such as the digital audio transcription system disclosed by U.S. Pat. No. 6,871,107 issued to Townsend et al. Such transcription system to Townsend et al. is designed for use during court proceedings and includes at least one source of audio signals to be recorded and a computer for storing digital signals corresponding to the audio signals for allowing the stored digital signals to be subsequently played back. Recording sessions are defined by signaling the start and stopping of the digital signals accomplished via a user interface that includes a recording control mechanism. The computer associates a date and time with each file segment stored during a recording session. A playback selection allows a user to select a virtual file entry from file entries corresponding to the periods of time during which the computer has stored at least one recording session. The computer is responsive to the playback selection to identify file segments stored in memory on the desired entry date from the selected source of audio signals, which collectively represent the selected virtual file entry. This transcription system requires user intervention in terms of the recording control mechanism.

In the area of aircraft communications, there exists U.S. Pat. No. 7,271,826 issued to Muirhead et al. Such patent discloses an arrangement for audio, video and/or data communication between a ground station and an aircraft. Such arrangement has at least one communications channel and a monitoring device provided on board the aircraft. The monitoring device includes at least one audio, video or flight data recording apparatus or combinations thereof, which can be activated either from on board the aircraft or by remote control from the ground station. The recording apparatus can be deactivated by remote control from the ground station and/or from on board the aircraft when it is on the ground. The arrangement also includes a memory for the data from the recording apparatus and a transmission apparatus for transmitting data from the recording apparatus and/or data read from the memory to the ground station. The transmission apparatus uses at least one communications channel in the arrangement for audio and/or video and/or data communication between the ground station and the aircraft. This arrangement requires user intervention in terms of either the aircraft personnel or remote access by personnel on the ground.

Further, in the area of recording audio transmissions, there are several known mechanisms for recording communications in a more automatic manner than the above-referenced patents. Such mechanisms relate to a voice operated switch, also known as Voice Operated eXchange (VOX). VOX operates when sound over a certain threshold is detected and is usually used to turn on a transmitter or recorder when someone speaks and turn it off when they stop speaking. VOX is often used to save storage space on recording devices. Typical VOX circuits usually include a delay between the sound stopping and switching directive so as to avoid having the circuit turn off during short pauses in speech.

Still further, in the area of aircraft communications, there exists well known “black box” technology which effectively records all cockpit recordings of voice and instrumentation data. Commonly, only a certain amount of data exists for any period of time which ranges from the most immediate 30 to 180 minutes. The use of VOX circuits can extend the timeframe for at least voice data. Cockpit data recorders however are generally limited to only the aircraft's data. Thus limitations in the amount and category of data are therefore limited. Such “black box” recorders are found in other fields outside of aircraft such as, but not limited to, commercial trucking, rail locomotive, and various vehicles requiring event recordation.

There is also known technology related to the next generation programs of the Federal Aviation Administration (FAA). Specifically, Automatic Dependent Surveillance-Broadcast (ADS-B) is the FAA's satellite-based successor to radar. ADS-B makes use of Global Positioning System (GPS) technology to determine and share precise aircraft location information, and streams additional flight information to the cockpits of properly equipped aircraft. The term aircraft as used herein may include any single and multi-engine, rotocraft (helicopter) and or UAV (unmanned aerial vehicle, e.g. a drone) that is designed for navigation in the air and that generates radio transmissions for voice, navigation or location information.

For example, in the area of aircraft communications, there exists U.S. Pat. No. 6,950,037 issued to Clavier et al. Such patent discloses a computer system that takes as inputs aircraft position and velocity, weather, and airport data, and uses such inputs to compute safe takeoff and landing sequences and other airport advisory information for participating aircraft. The computer determines whether the runway is occupied by another aircraft and the potential for in-flight loss of separation between aircraft. Such inputs are organized into useful information and packaged for graphical display. Computer-synthesized voice messages are broadcast over a data link and to aircraft via a local VHF transmitter. The intended use is to provide real-time data within a radius of an airport, such that the pilots in the area receive voice annunciated VHF-broadcast signals and data links with text and pictures for display.

Yet still further, in the area of airport management, there is no suitable mechanism for recording and archiving voice communications in a useful manner taking into account the availability of ADS-B data. This is particularly true of small airports such as are found in municipalities and townships across the United States, where sophisticated air traffic control systems are beyond the means and requirements for operational safety in unattended airports. It is, therefore, desirable to provide a robust, automated, VOX-type of communications system to overcome the problems associated with known systems and devices and to provide improved automated, communications management and which interacts with ADS-B.

It is further desirable to provide airport managers and the like with robust and accurate data sets to support systems planning and the management of an airport, and to present the data sets in such manner as to allow the manager of a small airport, for example, to very quickly identify patterns and anomalies from expected operational statistics. It is to further advantage to provide such data on aircraft operations within user-defined regions about the airspace of an airport, thereby focusing increased attention on aircraft operations within user defined zones for better systems planning and day-to-day management of the airport. Aviation System Planning is critical in understanding the existing and future needs at the airport. Having current technology for collecting accurate data on the types and frequency of aircraft types that are using an airport is critical in establishing local and FAA funding needs for airport infrastructure.

### SUMMARY OF THE INVENTION

It is an object of the present invention to obviate or mitigate at least one disadvantage of previous communications systems. Specifically, one object of the present invention is to aide an airport manager with systems planning, day-to-day airport management, and provides operational data on aircraft as a vital tool supporting the primary role of an airport manager in operating an airport in a safe and efficient manner. Understanding the types and frequencies of all aircraft and UAV's flying into and around an airport allows management to development work schedules around daily and seasonal aircraft traffic. Understanding the unique flight activity around the airfield assists in the comprehensive system planning for land use surrounding the airport as it relates to development and noise complaints.

In a first aspect, the present invention provides a low cost audio recorder affordable for general aviation, rail, bus marinas, etc., allowing for years of data recording on a single hard drive, allowing the airport management to track the usage of the airport and also allowing for playback of audio data files which can be used as a safety training tool by both airport management and flight school instructor.

In another aspect, this provides a way of tracking activity at airports, rail yards, marinas, etc. on how busy they are and at what times, based on minutes or seconds of radio traffic providing an alternative way of processing plane counts using radio wave allowing airport management to track growth trends in annual enplanements.

In a further aspect, the present invention can assist local and federal officials providing critical voice date during accident investigations.

In still another aspect, the present invention provides a recording apparatus for monitoring multiple radio transmissions at an unattended airport located within a geofenced area, the apparatus including: a radio device for receiving multiple radio transmissions from one or more radio transmission sources; a plurality of unique signature elements each provided to a corresponding one of the one or more radio transmission sources, at least one of the unique signature elements being aircraft identity data from an ADS-B equipped aircraft located within the geofenced area; a signal interface connected to the radio device, the signal interface including an ADS-B receiver capable of receiving ADS-B data including the aircraft identity data from the ADS-B equipped aircraft and a variable attenuator capable of selective operation with a plurality of other radio devices including the radio device; and a computing device connected to the signal interface, the computing device generating data corresponding to each of the radio transmissions.

In still another aspect, the present invention provides a system for airport data recording management, the system including: one or more radio transmission sources located within a geofenced area; a radio device for receiving multiple radio transmissions from the one or more radio transmission sources; a plurality of unique signature elements each provided to a corresponding one of the one or more radio transmission sources, at least one of the unique signature elements being aircraft identity data from an ADS-B equipped aircraft located within the geofenced area; a signal interface connected to the radio device, the signal interface including an ADS-B receiver capable of receiving ADS-B data including the aircraft identity data from the ADS-B equipped aircraft and a variable attenuator capable of selective operation with a plurality of other radio devices including the radio device; a computing device connected to the signal interface, the computing device generating data corresponding to each of the multiple radio transmissions, and a cloud-based server located at a central location and storing the data along with similar data related to additional unattended airports.

In a further aspect of the invention, there is a system for airport data recording management, the system including: one or more radio transmission sources located within a geofenced area; a radio device for receiving multiple radio transmissions from the one or more radio transmission sources; a plurality of unique signature elements each provided to a corresponding one of the one or more radio transmission sources, at least one of the unique signature elements being aircraft identity data from an ADS-B equipped aircraft located within the geofenced area; a signal interface connected to the radio device, the signal interface including an ADS-B receiver capable of receiving ADS-B data including the aircraft identity data from the ADS-B equipped aircraft and a variable attenuator capable of selective operation with a plurality of other radio devices including the radio device; a computing device connected to the signal interface, the computing device generating data corresponding to each of the multiple radio transmissions, and a cloud-based server located at a central location and storing the data along with similar data related to additional unattended airports, wherein the geofenced area is a user-defined polygon geofence in the physical environment surrounding an unattended airport. In some embodiments, the user-defined polygon may be defined as a single polygon, multiple polygons, polygons at an altitude and/or location in addition to a geofenced area in the airspace of an unattended airport. In other embodiments the user-defined polygons may record, summarize, store, report in graphical and/or textual formats the operational counts of aircraft within or passing through the polygon over a defined time period or period of days.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Embodiments of the present invention will now be described, by way of example only, with reference to the attached Figures.

FIG. 1 shows a generalized schematic of the system and apparatus in accordance with one embodiment of the present invention.

FIG. 2 illustrates a user of the present invention including a signature element providing a unique identifier to the user.

FIG. 3 shows one possible type of device as an example of the signature element of FIG. 2.

FIG. 4 shows one possible circuit configuration of a variable attenuator in accordance with the inventive system and apparatus.

FIG. 5 shows one possible output report in accordance with the inventive system and apparatus.

FIG. 6 shows one possible audiovisual output in accordance with the inventive system and apparatus.

FIG. 7 shows the preferred embodiment of the present invention including an ADS-B equipped aircraft further including geofencing.

FIG. 8 depicts a user interface dashboard showing graphical and textual outputs of data recorded according to several aspects of the present invention.

FIG. 8A depicts a component of the interactive dashboard showing intensity of radio transmission with interactive access to recorded voice transmissions.

FIG. 8B depicts an example readout of recorded ADS-B data according to one aspect of the invention.

FIG. 9 depicts a flowchart of an exemplary method of the present invention.

FIG. 10 depicts an example of geofence definition at a representative airport.

FIG. 11 depicts the creation of a user-defined polygon about the runway of an airport.

FIGS. 11A and 11B depict in enlarged mode the creation of the user-defined polygon about the runway of an airport and the setting of parameters for the user-defined polygon about the runway of an airport as shown in FIG. 11.

FIG. 12 depicts an example ADS-B graphic showing operations and aircraft activity within a user-defined polygon.

FIGS. 13A, 13B, and 13C depict additional examples of user-defined polygons, including single runway, cross runway, and parallel runway polygons.

FIGS. 14A, 14B, and 14C depict selection and results for a user-defined polygon reporting and mapping aircraft activity and identification information over selected region of interest in the area of an airport.

FIGS. 15, 15A, and 15B depict an example of ADS-B activity within the geofenced area over an airport, showing aircraft data by selected parameters.

### DETAILED DESCRIPTION

Generally, in one aspect, the present invention provides a system and apparatus for enabling unattended airports (e.g., small, municipal airports with limited staff and/or control tower hours) to have a useful archive of all radio communications made by aircraft and ground personnel. It should be readily apparent that while the foregoing invention details are described in terms of airport communications, the present invention may be implemented in terms of a rail yard, a harbor including marine and ferry services, school transportation departments, municipal public works departments, taxi/bus fleets, or any similar setting with vehicular traffic and where multiple parties may be communicating via radio transmissions. In implementation within any such setting, it should be readily apparent that the present invention is useful for performance of actions such as, but not limited to, accident reconstruction, personnel training efforts, and statistical analysis of activity and operations occurring within such settings based on data and voice radio transmissions captured, received, stored, processed and displayed by the system and methods described herein.

In this first aspect, the present invention uses a combination of hardware and software components to record and store radio transmissions in computer files. As mentioned, once stored, the computer files may then be replayed for training and investigation purposes. Likewise, the software allows a user to generate custom reports based upon the data embodied in the computer files.

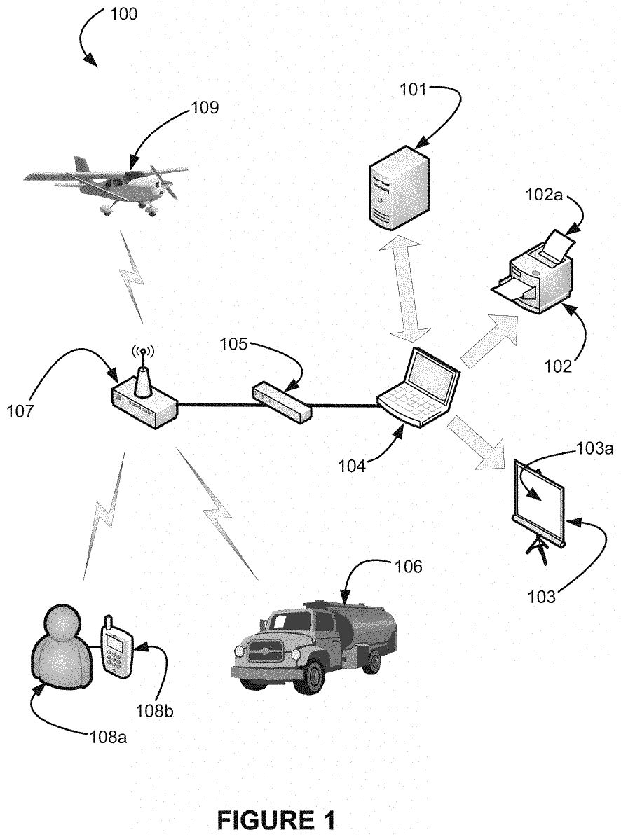

With reference to FIG. 1, there is shown an audio recording system 100 in accordance with the present invention. The system 100 includes a radio device 107 and a computing device 104 along with a signal interface located there between in the form of a variable attenuator 105. The radio device 107 may be a radio base station or scanner of any type or manufacturer known in the general avionics field. It should be understood that variations in the specific radio device 107 will necessitate the inventive system 100 to accommodate variations in signal power which is especially important when interfacing with a standardized computer input. Hence, the variable attenuator 105 is an electronic device that reduces the power of a radio signal without appreciably distorting its waveform and transfers it for digital manipulation by the computing device 104.

The radio device 107 may include a Universal Communications (UNICOM) station typically employed at airports with a low volume of general aviation traffic and where no control tower is present or active. UNICOM stations typically use a single communications frequency which may vary among different geographic locations. For example, the Common Traffic Advisory Frequency (CTAF) is the name given to the radio frequency used for air-to-air communication at US, Canadian and Australian non-towered airports. As well, some airfields always offer UNICOM service while others revert to UNICOM procedures only during hours when the control tower is closed. Under this protocol, aircraft 109 may call a non-government ground station, radio device 107, to make announcements of their intentions. Pilots who join the frequency later can request field advisories, which may include weather information, wind direction, the recommended runway, or any previously reported traffic.

The present invention is particularly useful in regard to instances where, depending upon the time of day and/or general level of airfield activity, the ground station may not be staffed. As such, attempts to communicate will therefore receive no acknowledgement. During these times, pilots of aircraft 109 self-announce their position and/or intentions over the CTAF frequency, which is often the same as the UNICOM frequency. When a part-time UNICOM station is located on the same airport as a part-time control tower, the same frequency will be used by both ground stations to avoid confusion. Many UNICOM stations are operated by a Fixed Base Operator (FBO) and it may be possible to request services from the airport such as fuel trucks 106, ground personnel 108a with handheld radios 108b, or other services (e.g., taxi services, fire services, etc.) and entities (not shown) which may also be communicating via the airport's radio system.

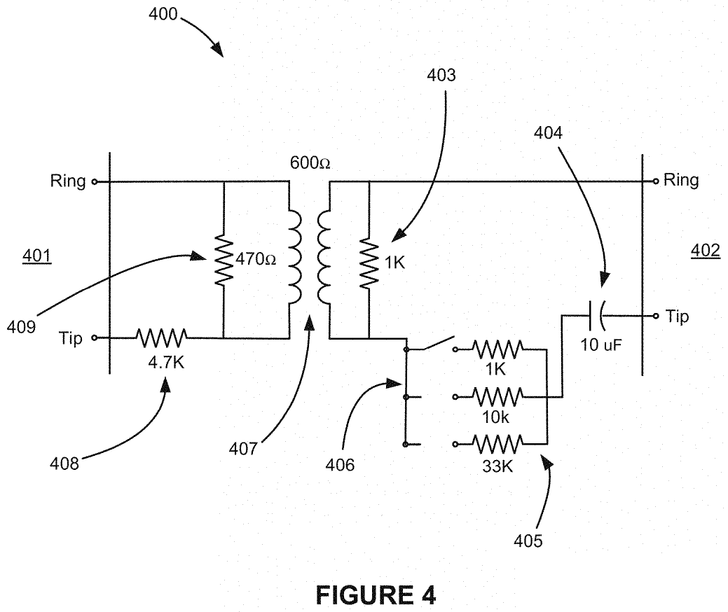

The system 100 will serve to accumulate all radio communications among radio sources which may be entities on the ground (i.e., 106, 108a) and in the air (i.e., 109). The variable attenuator 105 may be provided with a standardized radio jack to interface with the radio device 107. Accordingly, the variable attenuator 105 thereby accepts a wide level of input levels from a variety of radio devices. Moreover, the present invention uses standard 3.5 mm stereo phono plugs for connections at the radio side to thereby provide access to most radio devices. The computing device 104 will process radio communications from the variable attenuator 105 and one possible configuration for the variable attenuator 105 is shown and described in further detail with regard to FIG. 4.

The computing device 104 may be any type of computer or computer-related element such as, but not limited to, a desktop computer, laptop or notebook computer, or computing tablet device. Indeed, the ever improving size reductions in computers may even allow for the use of devices such as a smart-phone to be used as the computing device 104 so long as adequate computing capability is provided by the computing device 104 in order to process the raw radio communications into useful data. To that end, the system 100 in accordance with the present invention will also include data storage 101, customizable output 102 in the form of static reports 102a, and audio/visual (AN) output 103 in the form of graphical reports 103a with or without sound.

The data storage 101 will provide archives of all raw radio transmissions and any related information processed and thereby generated by the computing device 104. Such related information may include environmental data readings such as weather, temperature, wind, precipitation, and time of day data recorded concurrent with the radio transmissions. The data storage may be co-located with the system 100 or remotely located via networking to a cloud-based server. Likewise, a cloud-based server may be accessible to other related systems that may provide monitoring of multiple airfields from a centralized location.

It should be recognized that real-time archiving of continuous radio transmission may not be economically feasible. Furthermore, unattended airfields may generate more dead air than radio traffic. Accordingly, it should be readily understood that the use of VOX technology, or any suitable mechanism for reducing recorded dead-air, can extend the timeframe for at least voice data captured and stored by the present invention.

In operation, the present invention captures the audio feeding directly into the computing device after breaking the squelch of the radio device and digitizes the signal into a “way” format file. It is at this point the data is saved in two separate locations. Each file is saved in a day file such as “01/01/2013” and in each file a “way” file at the exact time the file started recording (e.g., 02:14:49). Either military or conventional time may be utilized. After multiple files are recorded, the present invention can extrapolate out the times using via suitable software processing—for example, the amount of transmissions and size of these files can provide radio traffic by hour, day, week, year, etc.

The customizable output 102 may be in the form of hard copy print outs reporting useful data such as the number of radio transmissions made during a given time period. Such a report may, for example, be of value in understanding the peak periods of use of an unattended airfield. Though the use of customizable software embedded in the computing device 104, it should further be readily apparent that a variety of reports may be generated to provide information about the radio transmissions, and thus, the activity of a given airfield.

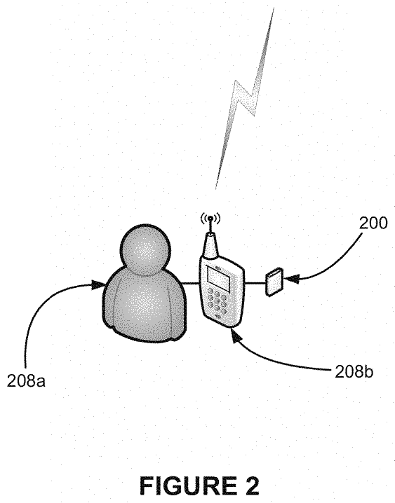

As shown in FIG. 2, the present system may also include a signature element 200 provided at a radio transmission source such a ground personnel 208a equipped with a handheld radio 208b. It should of course be understood that while personnel with a handheld radio is illustrated, any other radio device may be provided with a signature element in a similar manner. Such signature element 200 may be in the form of an electronic device that adds a dual-tone multi-frequency (DTMF) tone in the voice frequency prior to or immediately after any transmission by the given radio device. The DTMF tone would be a unique identifier and would therefore differ among differing types of radio transmission sources. In this manner, each source of a radio transmission (e.g., 106, 108a, 208a, or 109) would effectively transmit a radio signal begun (or ended) by a particular DTMF tone unique to that type of source. As such, the computing device 104 may include software that can recognize each differing DTMF tone and therefore group radio transmissions by, for example, the type of radio source. Thus, the customizable software may generate reports filtered by way of radio transmissions from aircraft, ground maintenance vehicles, emergency vehicles, or any other source of radio transmissions from a radio that includes the signature element.

It should be understood that in some installations the system may be implemented only in the given airfield in which the system is used. In such situations, it would be readily apparent that aircraft may or may not be equipped with a signature element. However, one or more ground based sources of radio transmissions may be so equipped and thereby include a corresponding DMTF tone such that they are differentiated from aircraft transmissions not including a DTMF tone.

In a preferred embodiment, aircraft are provided with a signature element in the form of known ADS-B avionics. Under the NextGen Air Transportation System and Single European Sky (SES), properly equipped aircraft broadcast their identity, position, track, speed and other vital data via what is called ADS-B “Out” technology. The present invention incorporates the identity aspect of the ADS-B “Out” technology from aircraft that include ADS-B avionics. More specifically, the ADS-B related identity data from such aircraft form the signature element in accordance with the present invention. In this manner, each aircraft incorporating ASD-B avionics thus provides the system and apparatus of the present invention with a suitable unique identifier in the form of a signature element (i.e., the broadcast identity data). Each such signature element, and correspondingly each aircraft, is uniquely trackable by the present inventive system and apparatus. In terms of FIG. 1, the aircraft radio transmission source 109 would therefore include a signature element formed from its identity data of the ADS-B “Out” technology.

The A/V output 103a may be in the form of digital sound files with or without corresponding on-screen images and data. One useful format for the A/V output 103a may be an on-screen image including an audio clip player with concurrent visual representation of sound by an analog signal wave. Concurrent on-screen images representing other processed data and information may also be provided including a thermometer, an anemometer, or any other representation of quantifiable data that could be of interest for purposes of, for example, accident reconstruction or personnel training.

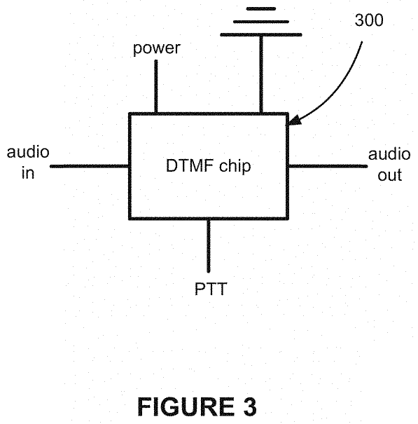

FIG. 3 shows one possible configuration of a signature element 300 that serves to embed a unique DTMF tone in each type of radio source. The signature element circuit may be implemented in the form of a typical electronic chipset manufactured to be easily attached to the intended radio source. Here, a DTMF chip is shown which may include audio in from a microphone, audio out including the embedded DTMF tone to the radio microphone or audio in, power, and push to talk (PTT) button from the radio. Moreover, the signature element 300 can be installed in the radio or microphone, needing only power, ground, audio out and the push to talk switch lines.

FIG. 4 shows one possible circuit configuration of a variable attenuator 400 in accordance with the present invention. In general, such circuit includes an impedance matching network with a 1-to-1 isolation transformer 407 along with a 10 uF capacitor 404 allowing no DC voltage to pass such that the radio 407 and computer 402 are electrically isolated from each other. More specifically, the circuit includes a radio side coupled to a computer side via a 600 ohm audio transformer 407. Tip and ring connections are provided at the input radio 407 and output computer 402 sides of the circuit. In implementing connections, commercially available cables may be used to couple the variable attenuator to the radio device and to couple the variable attenuator to the computing device. The radio side 407 includes a resistance 408 at the tip of 4.7K ohms and a 470 ohm resistor 409 across the ring and tip in parallel with the audio transformer. Variability is provided by way a dip switch 406 used to selectively tie 1K ohm, 10K ohm, or 33K ohm resistors 405 to the computer side tip connection through a 10 uF capacitor 404. A 1K ohm resistor 403 is provided across the ring and tip in parallel with the computer side 402 of the audio transformer. While specific values for components are provided, it should be readily understood that these are only illustrative of one possible embodiment and should not be considered limiting.

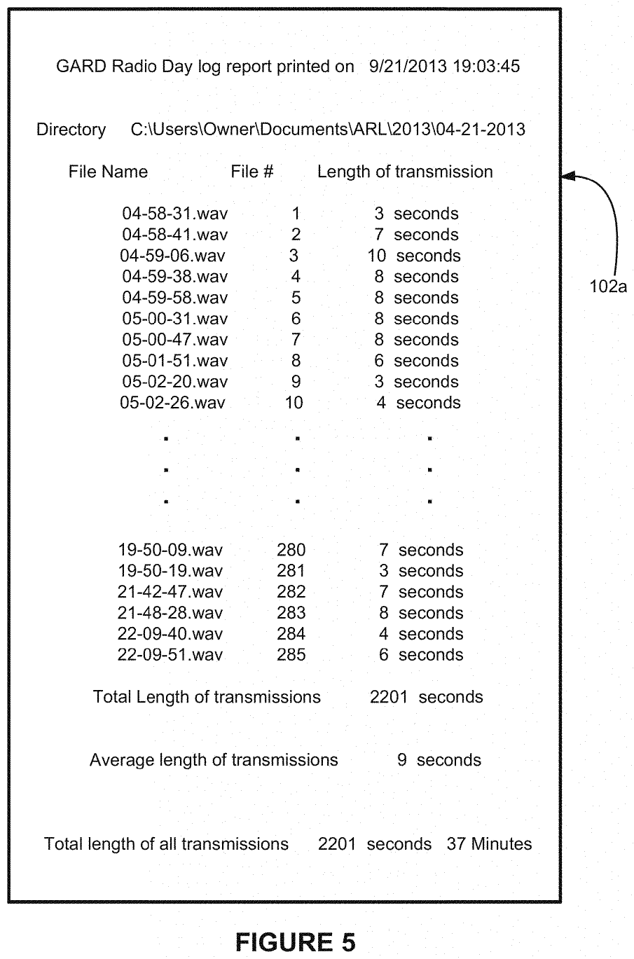

FIG. 5 shows one possible output report 102a which may be provided as a hard copy report of the present inventive system. The output report 102a illustrates a typical day report showing transmission lengths and exact times, also average length of transmissions.

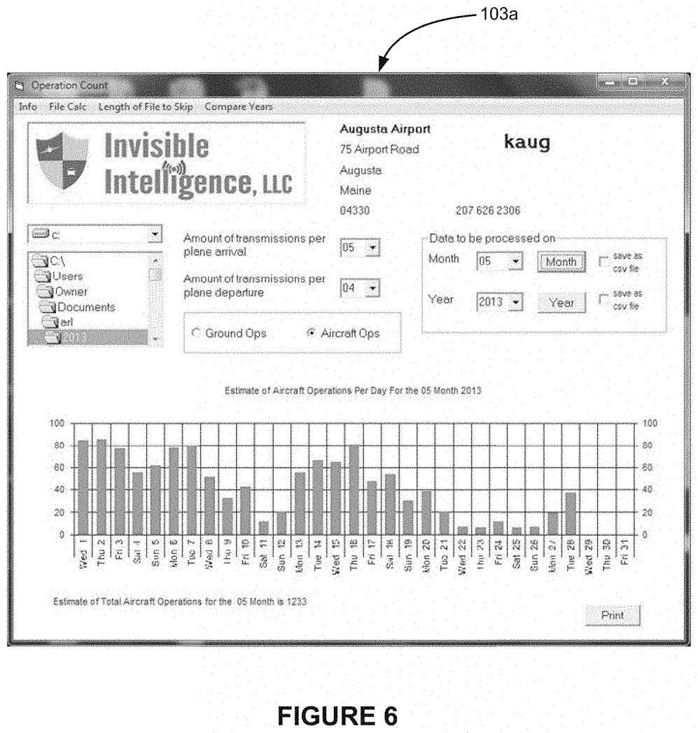

FIG. 6 shows one possible on-screen a/v output 103a which may be provided as an output of the present inventive system. Here, the exemplary screen shot provides a month of data and its conversion to aircraft operation counts.

It should be clear that such information as shown in FIGS. 5 and 6 as outputs of the present inventive system and apparatus is useful to many parties including airport management in a variety of tasks including, but not limited to, determining landing and takeoff information or forensic purposes regarding incidences of accidents.

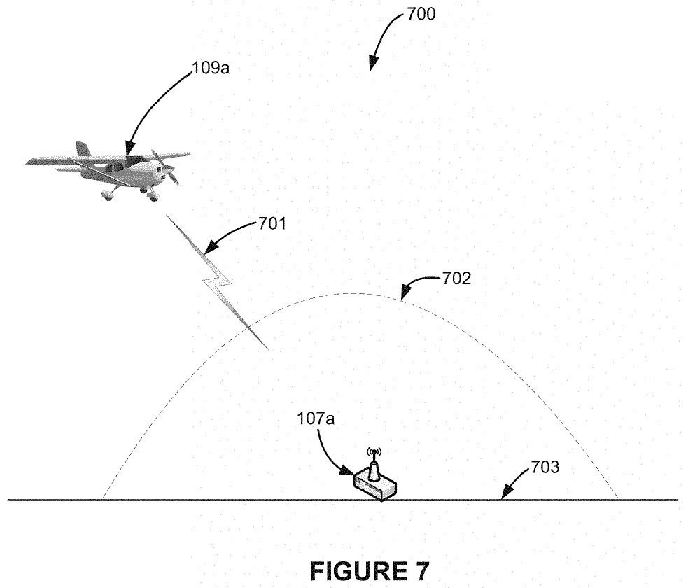

FIG. 7 shows the preferred embodiment 700 of the present invention including an ADS-B equipped aircraft 109a as previously described and further including geofencing 702. Similar to the radio device 107 shown in FIG. 1, the preferred embodiment 700 in FIG. 7 includes a radio device 107a which is modified to include an ADS-B signal receiver to receive an ADS-B “Out” signal 701 from the aircraft 109a. In terms of the present invention, the signal 701 is a unique signature element.

It should be understood that all other system elements as previously shown in FIG. 1 in addition to the radio device are of course also provided for within the preferred embodiment 700, though they are omitted from FIG. 7 for clarity of illustration. Such ADS-B signal receivers are well known in the aircraft radio art and not further described herein. In terms of the present invention, geofencing 702 denotes a virtual boundary defined in the physical environment surrounding an unattended airport where the radio device 107a is located. This may include, for example, an airspace involving a radius of one (1) mile around a center of such unattended airport up to a ceiling of one thousand (1,000) feet above the ground surface. In the instance of FIG. 7, this is seen as a dome (i.e., semi-sphere) rising from ground level 703 around an unattended airport where the radio device 107a is located. Of course, it should be understood that the specific size and shape of the airspace may vary according to user preferences and the particular requirements of any given implementation. Also, it should be readily apparent that the concept of a virtual boundary is created by way of known geofencing methodologies. As such methodologies are within the understanding of one skilled in the location based services art, they are not explained herein in any significant detail. However, in terms of the present invention, there are a couple ways to accomplish geofencing.

To accomplish geofencing with regard to the present invention, one way is to provide a mathematical formula to see how close the aircraft is to a reference point (e.g., center of airport) where this would form a large circle and anything within so many yards would be considered a valid entry. Another way is to set various GPS points on a map thereby forming a box and by using a series of < or > signs one can determine if the GPS latitude (Lat) and longitude (Lon) are in the box.

```
For example,
if Lat1 <= Lat(aircraft)
  and
Lat(aircraft) >= Lat2
  and
Lon1 <= Lon(aircraft)
  and
Lon(aircraft) >= Lon2
  then
entry is valid.
```

For purposes of illustration, one possible code implementation to identify whether an aircraft is within the geofenced area around the unattended airport may be:

```
  Dim Lat1 = 44.327784
  Dim Lon1 = −69.803752
  Dim Lat2 = 44.315396
  Dim Lon2 = −69.795113
  Dim Lat3 = 44.317219
  Dim Lon3 = −69.798218
  Dim Lat4 = 44.320722
  Dim Lon4 = −69.789023
  Dim Aircraft_Lat = 44.320774
  Dim Aircraft_Lon = −69.78933
  Dim y
  If Aircraft_Lat < Lat1 And Aircraft_Lat > Lat2 And Math.Abs(Aircraft_Lon) <
Math.Abs(lon3) And Math.Abs(Aircraft_Lon) > Math.Abs(lon4) Then
  y = 1
  TextBox3.Text = “aircraft in gps cords”
ElseIf y = 0 Then
  TextBox3.Text = “plane not in gps cords”
  ‘Stop
End If
```

As mentioned, an aircraft equipped with ADS-B “Out” avionics will broadcast their identity, position, track, speed and other vital data. Once such an aircraft is identified within the given geofenced area of an unattended airport, this broadcast data is used to track aircraft movement including, but not limited to, where such aircraft is parked, whether it taxied and took off or just landed, which runway it used, what direction it traveled, and the like. While aircraft audio transmissions and aircraft ADS-B transmissions are of course distinct from one another, either or both may be used to track operations at an unattended airport by way of the present invention. In particular, this tracked aircraft movement within the geofenced along with aircraft identity may then be paired with audio and date/time stamping to form output data which provides improved operational count capabilities—e.g., runway usage data may therefore be automated through the use of ADS-B “Out” broadcast data in conjunction with the present invention. Moreover, the present invention provides the ability to perform counting and tracking of aircraft at general aviation airports (i.e., unattended airports) via ADS-B. As previously suggested, it should be readily apparent that this capability would be enabled by providing the circuitry of FIG. 4 with an additional ADS-B receiver chipset by any known manner in the electronics art.

Having thus described geofencing at an unattended airport and corresponding tracking of an aircraft equipped with ADS-B “Out” avionics, it should also be noted that multiple aircraft equipped with ADS-B “Out” avionics may be encountered at more than one geofenced unattended airport. As previously mentioned, data storage in accordance with the present system may be co-located with the system or remotely located via networking to a cloud-based server. Likewise, a cloud-based server may be accessible to other related systems that may provide monitoring of multiple airfields from a centralized location. In this manner, flights between and among multiple unattended airports may be tracked across a larger geographic area. For example, a first unattended airport may store aircraft movement data while an ADS-B equipped aircraft is located within the corresponding first geofenced area, and later that same ADS-B equipped aircraft will be tracked at a second unattended airport. Because such data from the first and second unattended airports are stored in a centralized location, this data may be processed to provide aircraft tracking information among multiple unattended airports. The more airports and aircraft that are included in the network will result in a greater overall amount of tracking data that may be used for useful purposes such as, but not limited to, three-dimensional representations and air traffic modeling.

Interactive Dashboard

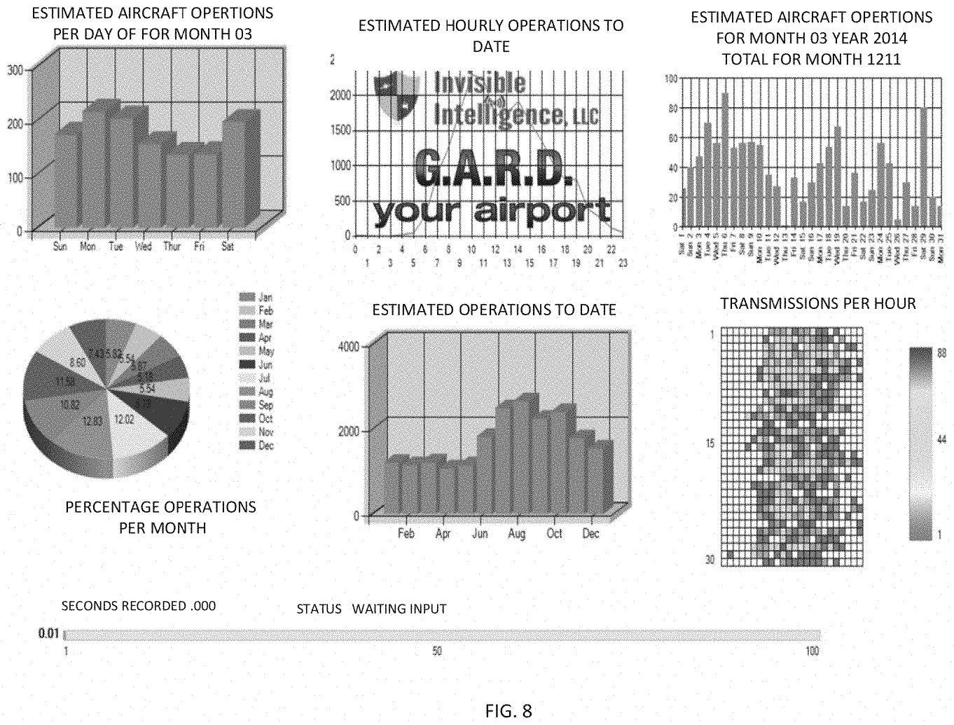

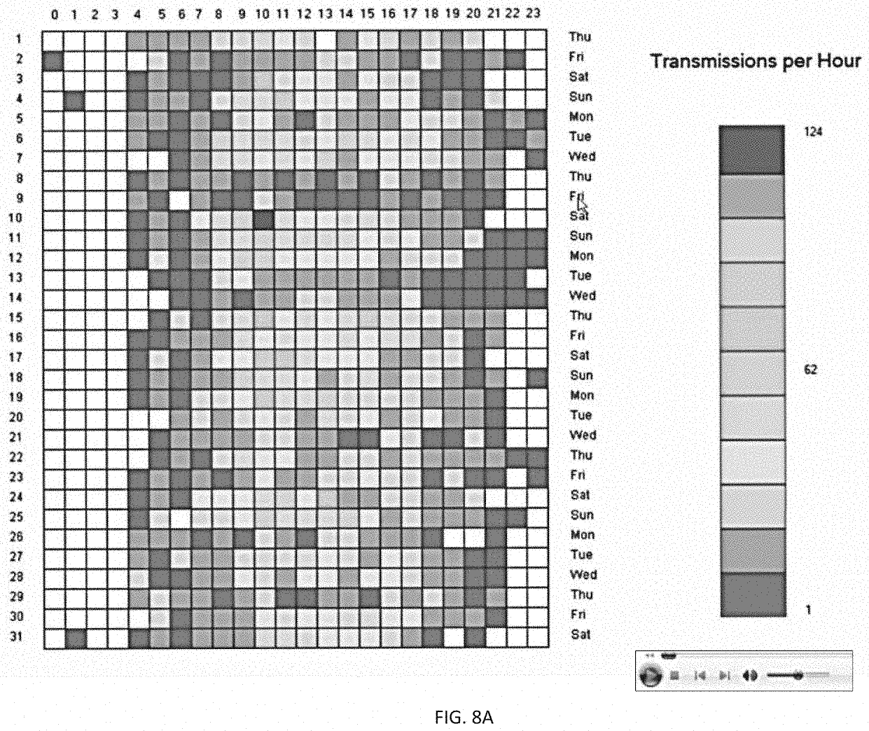

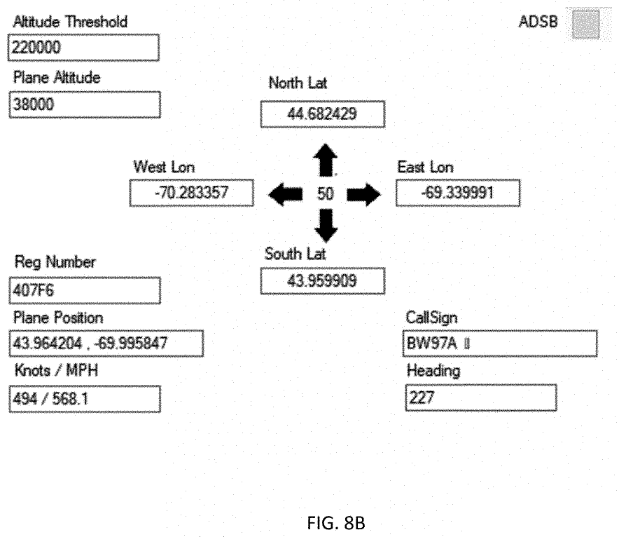

In one embodiment of the present invention, an interactive display on a graphical user interface of the computer may provide an airport manager with statistical summaries of aircraft operations based on data obtained from the above described system and methods. FIG. 8 depicts one such interactive display. Such interactive display may include a real-time indicator of radio transmissions activity and recording.

As used herein, the term an “operation” or an “operational count” is defined as one arrival (landing) and one departure (take off) of an aircraft. Thus, operational counts are used herein refers to the number of or an estimate of the number of takeoffs and landings of aircraft within the geofenced area, where each takeoff and landing is one operational count. One of ordinary skill in the art would understand one takeoff and one landing to count as one operation. In one aspect of the present invention, advantageously, operational counts may be determined from the received and stored radio transmissions, without the need for a separate system. By processing stored radio transmissions data and applying to the data an analysis of average, historical, or a regulatory number of required radio transmissions during typical aircraft takeoffs and landings, a count of operations can be automatically determined. In addition, in some embodiments, the analysis of the time between radio transmissions and the time of the transmission may be used to determine operational counts.

For example, the minimum number of radio transmissions of an aircraft required by the FAA upon arrival at an unattended airport may be 5 radio transmissions. Similarly, the number of radio transmissions of an aircraft required by the FAA upon departure from an unattended airport may be 4 radio transmissions. As above, as each of the radio transmissions in the geofenced area of the inventive system has been captured and recorded, the number of operations (one takeoff and one landing) can be accurately estimated by dividing the total number of radio transmissions by the average of 5 and 4, or 4.5. It is understood that the number of radio transmissions may vary and thus a different divisor of the total radio transmissions may be applied. Furthermore, radio transmissions lasting shorter than a time period, for example less than 3 seconds suggesting an incomplete transmission, or longer than a typical radio transmission, for example 12 seconds suggesting a conversation between pilots, may be filtered from the total number of radio transmissions for more accurate operational counts. Additionally, as above radio transmissions identified as ground station transmissions may be excluded to remove maintenance facility and vehicle transmissions from the total radio transmissions.

Additionally, the time between radio transmissions may be used to include or exclude radio transmissions in the total transmissions. For example, automated aircraft ADS-B Out transmissions may be repetitive transmissions at regular time intervals, such as 0.1 seconds, resulting in an increase of total radio transmissions. However, by including in the total radio transmission only such transmissions as occur after a selected time interval, for example, an at least three-minute time interval, repetitive or erroneous operational counts estimation is avoided. It is understood that such parameters, i.e. number of transmissions, time between transmission, average or regulatory number of transmissions per takeoff or landing may be different without loss of generally to the method of estimating operations as described herein. Additionally, ADS-B provided altimeter data in comparison to and within a range of airport altitude may be used to exclude or include radio transmissions relating to take offs and landings from the total radio transmissions.

Returning to FIG. 8, shown on the interactive display are graphics depicting aircraft operations for an airport over selected time periods displayed by useful segmentations. For example, Estimated Aircraft Operations Per Day of the week for a single month shows in one snapshot the weekday and weekend for day of the week comparisons of operational counts. Estimated Hourly Operations depicts the number of hours in each hour for a selected time period. Estimated Aircraft Operations for the Month and Year demonstrates the capability for the operational count graphs to look back in time, over a user selected period. These and other such graphs as may further depict operational counts are instantly useful to the airport manager as patterns and anomalies in a time period are easily identified. Such graphs assist the airport manager, regulators, funding and maintenance personnel at understanding the demands and trends of the operational load on the airport. Each of the graphs shown on the interactive display as in FIG. 8 may be selected individually and shown separately. It is understood that such graphs may have interactive elements to show or select data for viewing, and for settings for selecting data to be processed into such graphics.

As above, accompanying the radio transmission data for each voice transmission is a recording of the audio within the transmission. As such, the Transmissions Per Hour graph of the dashboard of FIG. 8 provides ready visual access to the operational statistics of a month of data as well as to the stored voice recording. FIG. 8A shows an enlarged display and interface to the Transmissions Per Hour graph as a “heat map” or grid of the number of radio transmissions recorded in each hour of each day for one selected month. The number of radio transmissions occurring in each hour is shown by the gradient color chart. The Transmission Per Hour display is interactive. Selection by the user of an hour block within the grid begins playback of the voice transmissions recorded during the selected hour's capture of radio transmissions.

An additional dashboard display element, which may be displayed individually as shown in FIG. 8B or as an element of the dashboard of FIG. 8, depicts the real-time processing and receipt of ADS-B data from an identified aircraft within the geofenced region about the airport. FIG. 8B depicts the identification of an aircraft, the system having received real-time data from the aircraft via ADS-B radio transmission. As previously described, the present invention provides geofencing using ADS-B GPS-based aircraft location data. The geofence region may be defined by a center point and a radius about the airport, or it may be defined by a “box” region, whereby a determination of “in” or “out” of the geofence is straightforwardly calculated as above. Specific geographic measures, locations, boundaries, and aircraft identifiers shown in FIG. 8B are exemplary only. For example, FIG. 8B shows the longitudes and latitudes defining a box geofence centered on an unattended airport, at 50 miles from its center. Geofencing using the location data of ADS-B may provide for radio transmissions capture and recording for only transmissions from aircraft within the defined area.

Geofencing may be applied in real time to prevent such capture and recording, or it may be applied in processing of captured and recorded data without loss of generality for the capabilities and advantages described herein. The real-time display of FIG. 8B on the dashboard of FIG. 8 may be concurrent with the capture, recording, and storage of ADS-B radio transmissions and voice radio transmissions as above. Capture and storage of ADS-B data may include recognizing new aircraft and scanning for new aircraft from 0.1 second to 2.5 second intervals, and capturing and but not storing ADS-B data based on an altitude threshold, or storing data from aircraft above the threshold in an alternative log file to avoid processing overflights and the like.

Capture, display, storage, and processing of ADS-B data may include data for each ADS-B Out transmission, such aircraft data including Transmission Date, Time, ICAO, Manufacturer, Model, Wingspan, Length, Tail Height, Max Takeoff Weight, AAC, ADG, Weight Category, Engine Type, Owner, and Owner registration information including Street, City, State, and Zip Code. Such received ADS-B Out data may be stored in its entirety or in part, or selectively stored. Data storage of ADS-B data may be in computer files organized in a hierarchical folder structure by airport, by day, by aircraft identifier or other such data structures as may facilitate real-time or post-recording processing. Such data, when filtered through and analyzed by and displayed by methods of the present invention such as Polygon Geofencing to be further described below, provides airport managers, regulators, safety and funding agencies and the like with critical aircraft and aircraft operations information necessary for the current and long-term functioning of one or more unattended airports under their direction.

User-Defined Polygon Geofencing

In a further aspect of the invention, users may create additional, custom polygons defining two- and three-dimensional regions with the airport geofence. User-defined polygons may be used for obtaining operational counts and the reporting of operational count and aircraft identification data and other data in the manner previously described for the geofence about the airport. Additionally, user-defined polygon parameters may include specifying a minimum altitude, a maximum altitude and a time or time period for recording operations counts at unattended airports. Aircraft identification and other data from unattended airports may include height, time and day and may be processed, summarized, combined with and reported in graphical and/or textual formats for aircraft within and passing through the user-defined polygons within or outside the geofence as shown and described above. Further utility of polygon geofencing as shown and described herein may be found in user-defined polygons aligned with runways for obtaining data on runway usage, cross-wind runway usage, and other runway usage measures such as time of day. Aircraft identification, speed, heading, altitude, latitude and longitude obtained by ADS-B or by other location or motion identifying or determining means may be used to determine operational counts within a user-defined polygon geofence.

Operational counts may be determined by the point location of an aircraft within a 3D polygon defined by the user, or by the location and heading, or by the passing of the aircraft through a 2D polygon defining all of or a portion of a user-defined 3D polygon geofence in the airspace of an unattended airport. It would be understood that any graphical or trigonometric or general mathematical method or means of determining operational counts within a user-defined customized polygon geofence may be employed without departing from the scope of the invention described herein. One such algorithm for generalized use may be readily found and implemented in open source software databases, such as can be found at the url: https://stackoverflow.com/questions/4287780/detecting-whether-a-gps-coordinate-falls-within-a-polygon-on-a-map. Further to implementation details, algorithms and software for displaying and selecting polygons and features within generalized maps may be readily found and implemented in Google Maps (GMAPS)[™] at url: https://www.google.com/maps.

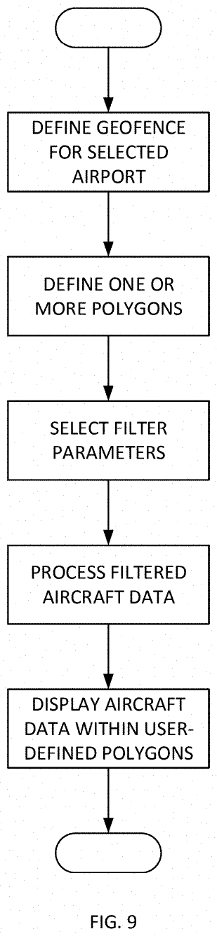

FIG. 9 depicts a flowchart describing an exemplary method of Polygon Geofencing. Using Polygon Geofencing, as will be shown and described more fully below, users select a day or multiple days on which to process radio transmissions data including ADS-B Out data captured and stored by the system and methods previously described. Users can identify single or multiple aircraft in specific polygonal areas on a specific day, multiple days, and specific times of day or at non-specific times of a day. User created polygons may be multipoint, comprising three or more points in space to define an arbitrary two- or three-dimensional polygon within which operational counts and aircraft identification and other data may be recorded, processed, and summarized in textual or graphic format, or transmitted and combined with other data.

In a first step of an exemplary method, the boundaries and other parameters of a geofence are determined relative to a center point and an altitude, for example, the center point of an unattended airport and its altitude above sea level. Such center points and altitudes may be obtained automatically from a database of geographic airport location and altitude data. Further definition of the geofence may set an upper boundary at an altitude and an equidistance in miles or kilometers or other distance measure to the geofence perimeter from the selected center point of the airport. Together, the center point, distance, and altitudes may define a box or a cube-shaped geofence for use as above and as further depicted and described. The geofence may be further associated with typical or historical operations times, for example, “Minutes Between Planes.” Storage of data may set to exclude or include ADS-B transmissions beyond the defined geofence or above a defined altitude.

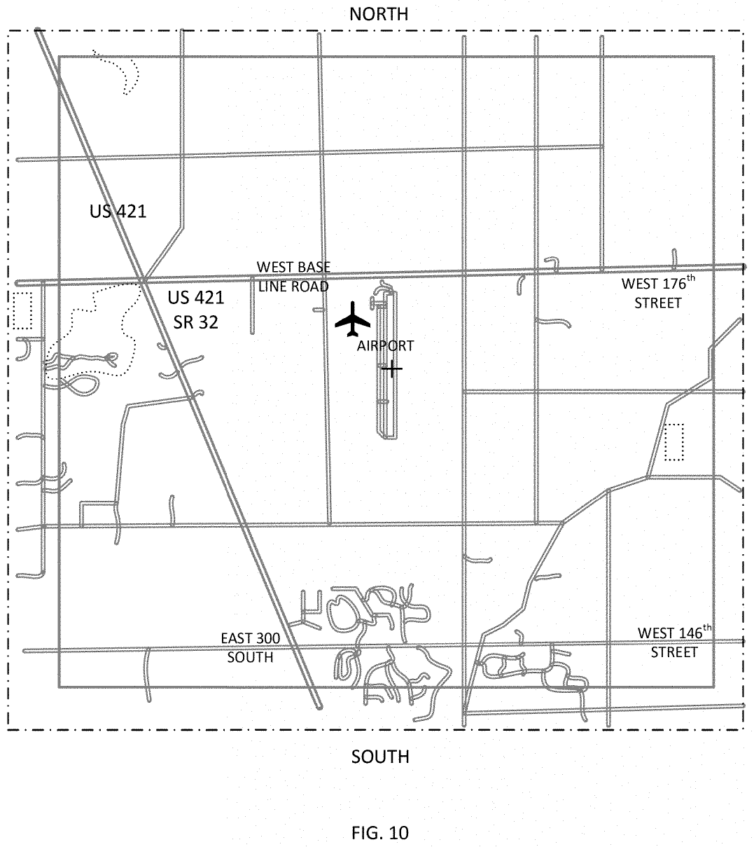

For example, as shown in FIG. 10, selected airport “Indianapolis Executive Airport” is depicted on a graphical user display along with an aerial map of major roads and significant geographic elements in the area of the airport. The geofence boundary is shown as a square of five miles across in each direction and centered on the center point of the airport. As previously noted, the size of the horizonal geofence boundary may be more or less in length and width. The geofence may be centered about the airport or not centered on the airport depending, in part, of the region of interest for aircraft operations and activity, and the proximity of the selected airport to other airports. The altitude of the vertical boundaries of the geofence may be the altitude of the airport at the lower boundary, and 5000 feet above sea level at the upper boundary or at any altitude including a very high altitude to define the geofence as the airspace above the airport within the five mile square latitudinal and longitudinal boundaries.

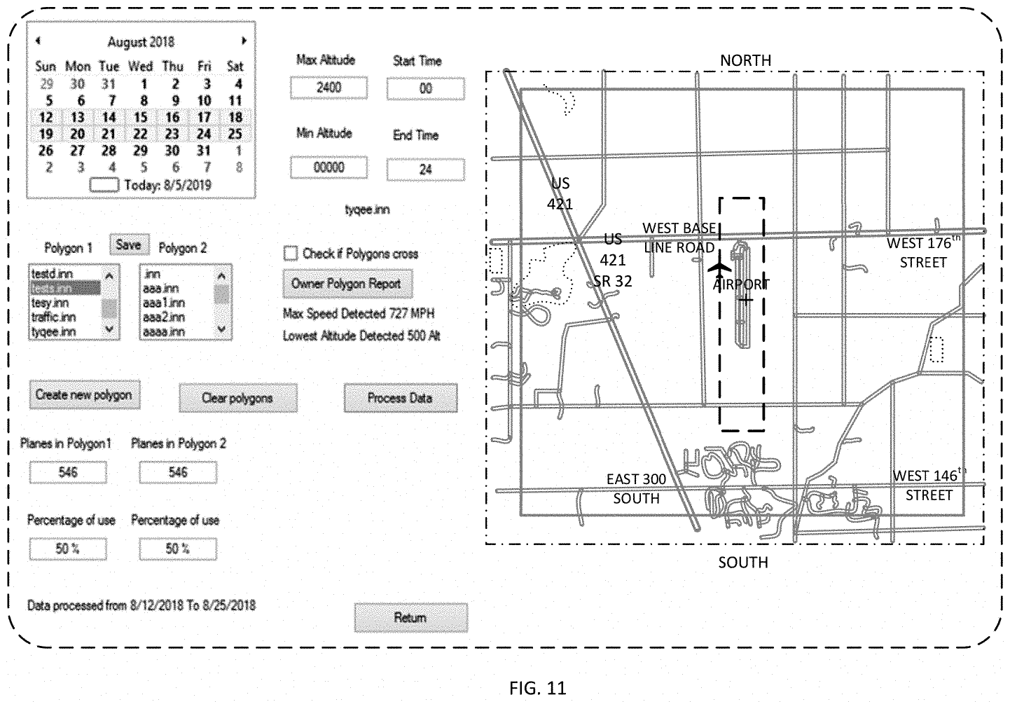

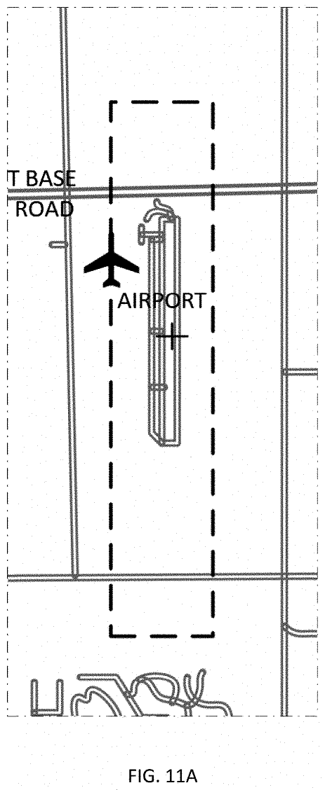

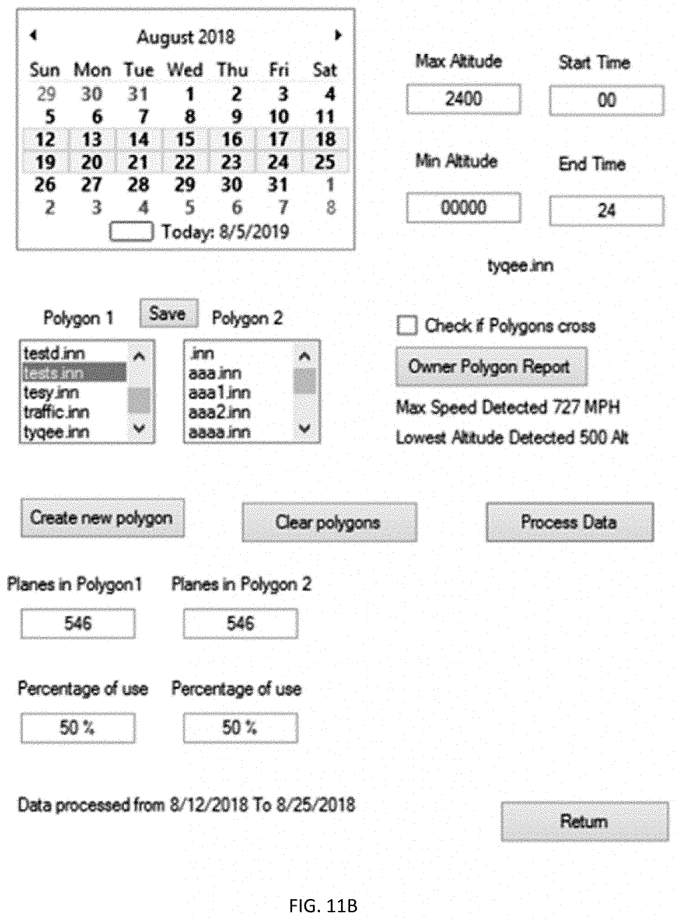

In a second step of the exemplary method, interacting with a pointer on the map of the airport as in FIG. 10, or by manual input, the user may create one or more polygons about the airport of any desired shape or extent. For example, as shown in the full screen display of FIG. 11, with further detail shown enlarged in FIGS. 11A and 11B, the user may create a user-defined polygon about the runway and taxi ways of the airport with a lower bound at the airport altitude and the upper bound at a selected altitude. In the example shown, one polygon is created about the airport as shown defining a box with lower and upper altitudes of zero (0) and 2400 ft, respectively. User-defined polygons may be used to create one or more two- or three-dimensional polygons anywhere in the airspace, at any rotation, attitude, and altitude, either inside or outside the geofence.

For example, for an airport with main and crosswind runways, two crossing runways, or two parallel runaways, the user may create two user-defined polygons, one for each runway. The enlarged user interface of FIG. 11, as shown in FIG. 11B, provides for two user-defined polygons; however, it is understood that the method and interface as shown in FIG. 11B showing Polygon 1 and Polygon 2 selections, may be expanded to three (3) or more polygons in or about a single geofenced airport. User-defined polygons may be saved for later use or selection as either Polygon 1 or Polygon 2, and polygons may be cleared or redefined via the user interface as shown.

In a third step of the exemplary method, the user may select filtering parameters such as date and time for processing ADS-B data and/or for displaying the processing results for prior recorded data according to the user-defined polygon(s). For example, as shown in FIG. 11B, the user has selected for processing archived ADS-B data acquired from a prior time period, specifically from the dates of August 12 to August 25. In the example shown, the user has set the maximum altitude and minimum altitudes for processing at 2400 ft and 0 ft, respectively, and has selected a Start Time and End Time for the 24 hour day. Other filtering parameters (not shown) may include aircraft type, aircraft class, size, weight, owner, frequency of operation, and other parameters for selection and filtering of the processed and displayed aircraft data during the selected date and time periods and other applied filtering parameters accordingly.

In a fourth step of the exemplary method, the captured and stored aircraft data is processed according to the geofence parameters, user-defined polygon(s), and filtering parameters as selected and described above. Captured and recorded ADS-B data is filtered for altitudes, minimum and maximum, date and time periods. The processed data may be transformed into statistics or graphical elements for storage or display.

In a fifth step of the exemplary method, the processing of aircraft data according to the geofence parameters, user-defined polygon(s), and filtering parameters as selected and described above may result in textual and graphical outputs for display on an interactive user interface. Textual outputs on the user interface of FIG. 11B may include a count of the number of distinct aircraft in Polygon 1 or Polygon 2, and the Percentage of Use of the total aircraft data selected and processed for each user-defined polygon. Textual outputs may include reporting the Max Speed Detected and Lowest Altitude Detection within the user-defined polygons.

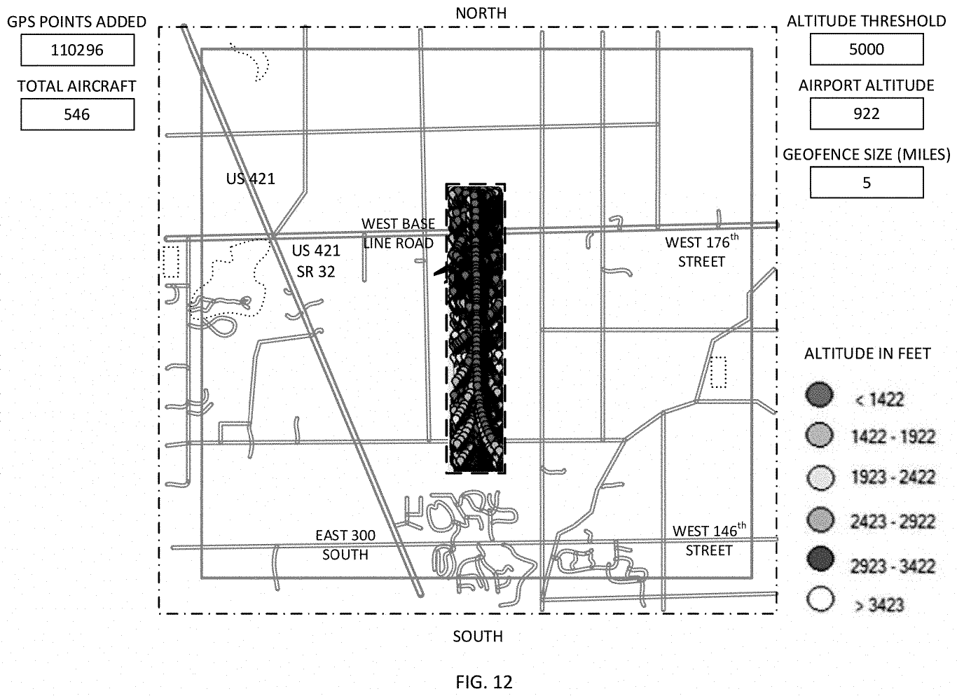

FIG. 12 shows an example of displaying of results from the processing of aircraft data using the geofence, selection, and filtering parameters given above in the example of FIGS. 11, 11A and 11B. Here, the selected and filtered aircraft data is indicated by a color-coded dots shown at each point on the map where an ADS-B Out radio transmission indicated the location of an aircraft within the user-defined polygon of FIG. 11A. The color-coded graphic in this example demonstrates a concentration of aircraft data indicators at lower altitudes (e.g. below 1422 ft) as would be expected for a landing zone of an airport. It would be understood that the graphic display of aircraft indicators may be displayed in a different manner than shown, with a different scale and range of altitudes than shown, according to the ground altitude of the airport and other local or user-selected parameters.

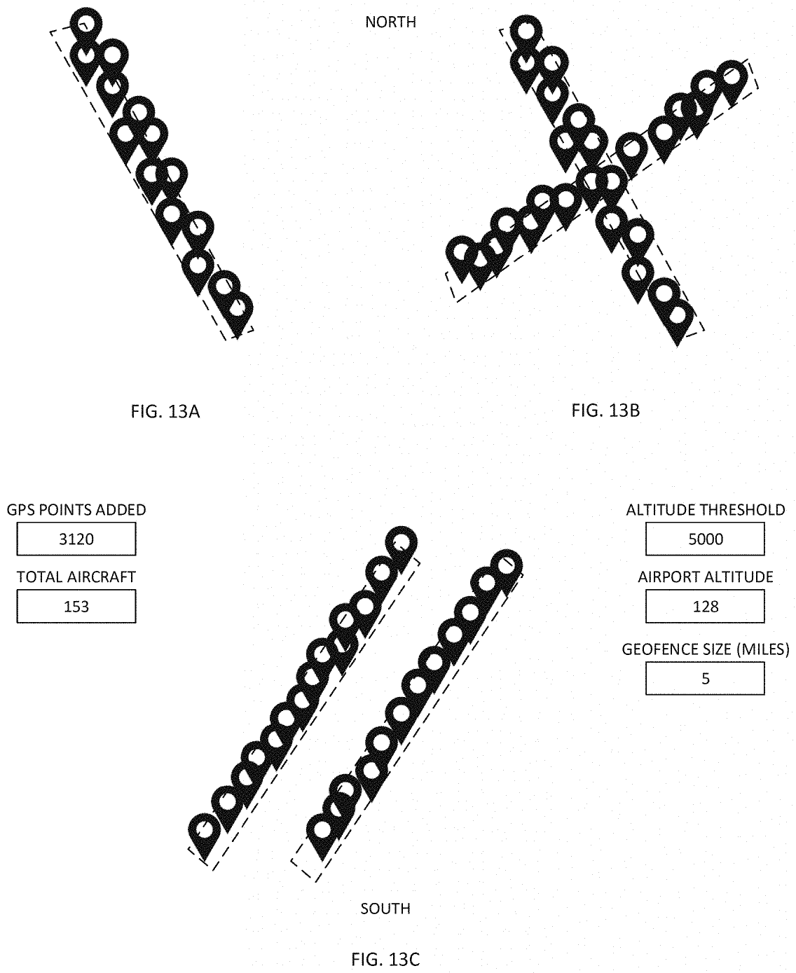

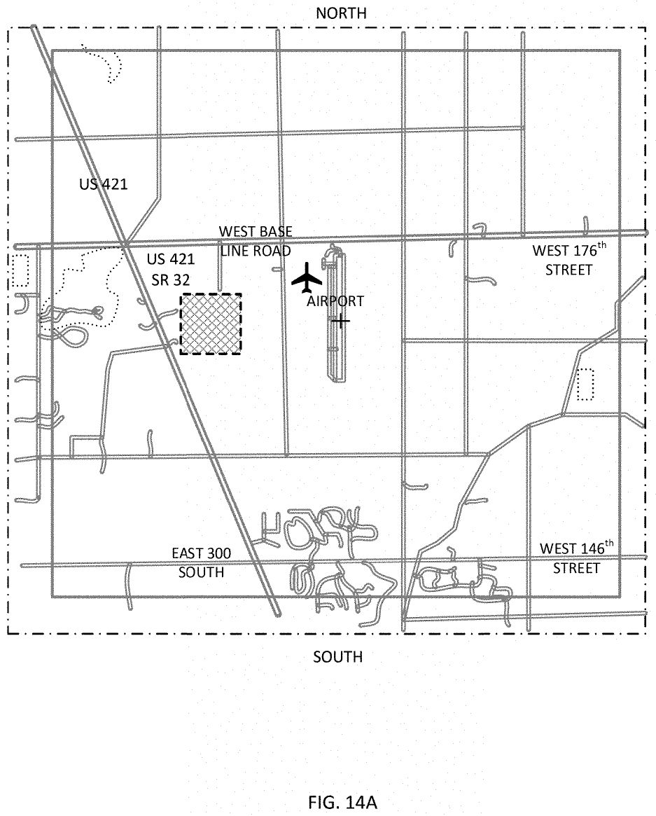

Selection of an aircraft indicator or indicators on the map may provide the user with interactive information about each or several aircraft or aircraft operations. It is also noted that the map provided may be scaled and the aerial map removed, scrolled or scaled for viewing the user-defined polygons. In addition, the color-coded graphic may be further limited, for example, as shown in FIGS. 13A, 13B, and 13C, to show only data at the lowest altitude (takeoff and landing altitudes, generally) in the user-defined polygons made over a single, cross, and parallel runways of an airport, respectively.

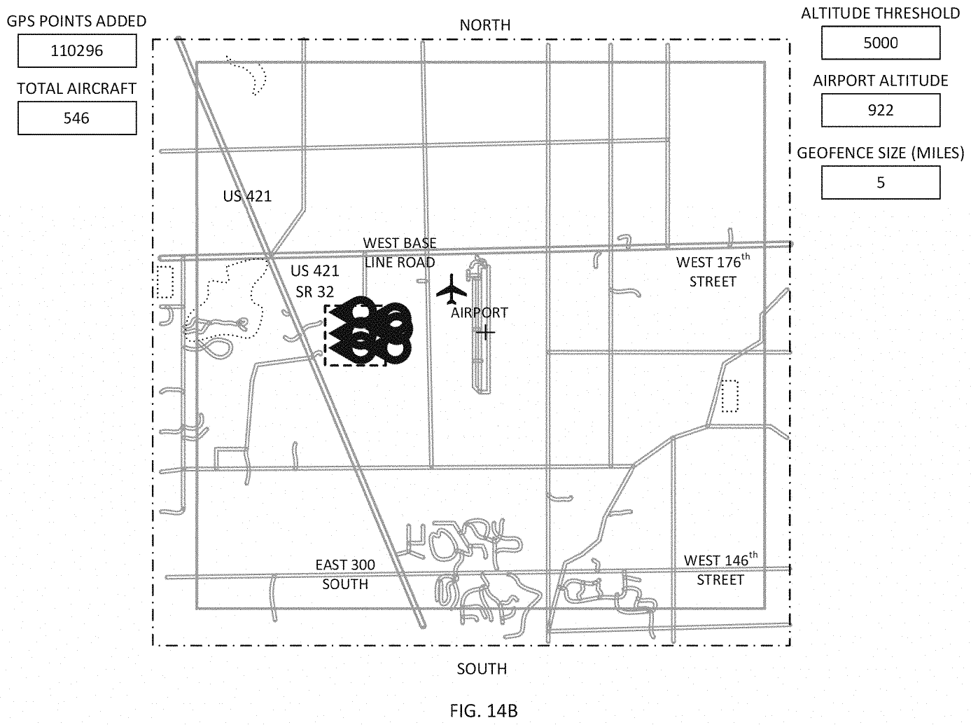

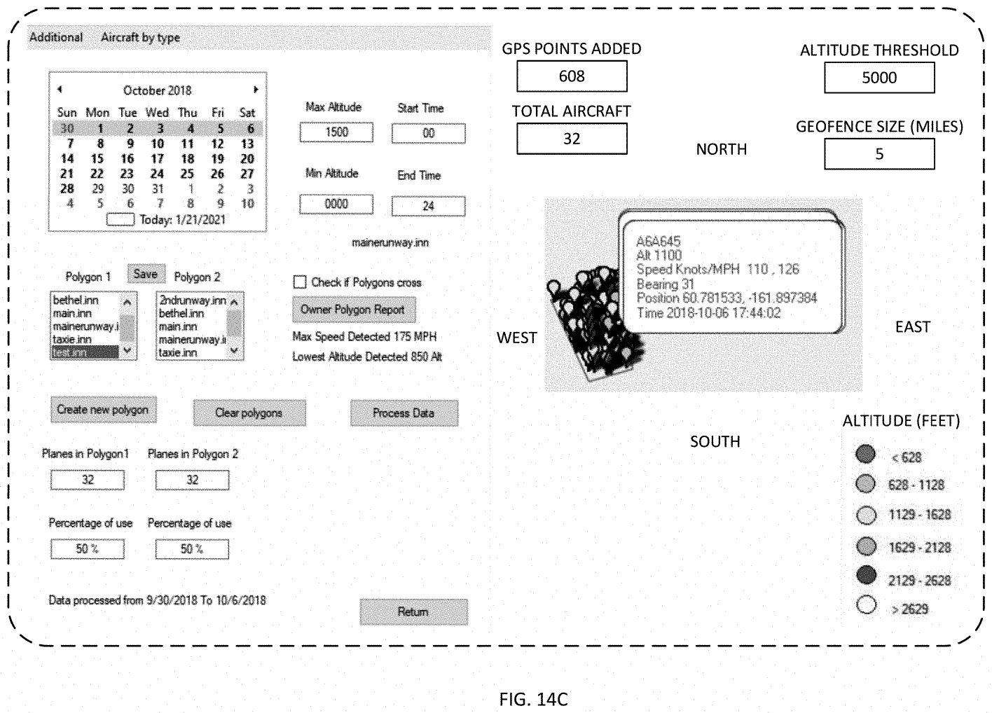

User-defined polygons may also be defined over regions not in a specific runway or taxis area of the selected airport. For example, FIG. 14A depicts a user-defined polygon (in red) over a planned residential housing development. Using the same system and methods as previously described for user-defined polygons over runways, the polygon shown in FIG. 14A, when applied to selected, filtered and processed aircraft data, provides textual and visual display of activity in the airspace over the planned development. As shown in FIGS. 14B and 14C, it would be understood that such user-defined polygons and the processing and reporting within could be employed for multiple advantages in long-term systems planning, airport regulation, safety, capital allocation and funding, and dispute resolution in any area of aircraft activity using the system and methods of the present invention. For example, as shown in FIG. 14C, such processing and reporting could provide all of the above including specific identification of aircraft entering and departing the airspace. Additionally, entering the airspace defined by a user-defined polygon may be determined by further processing the aircraft data to recognize when an aircraft has passed through a boundary of the polygon.

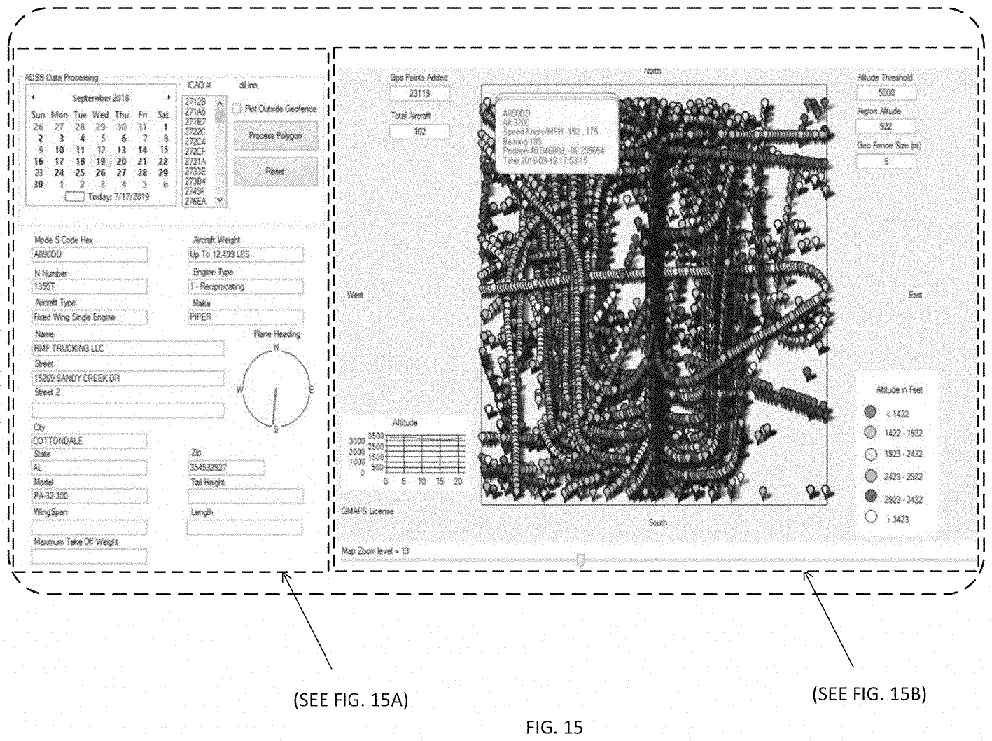

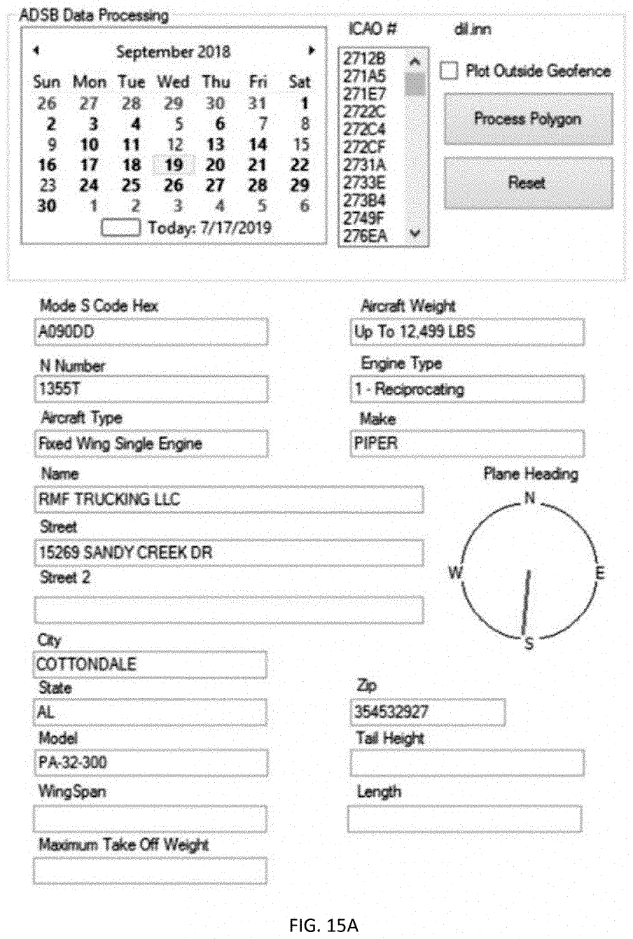

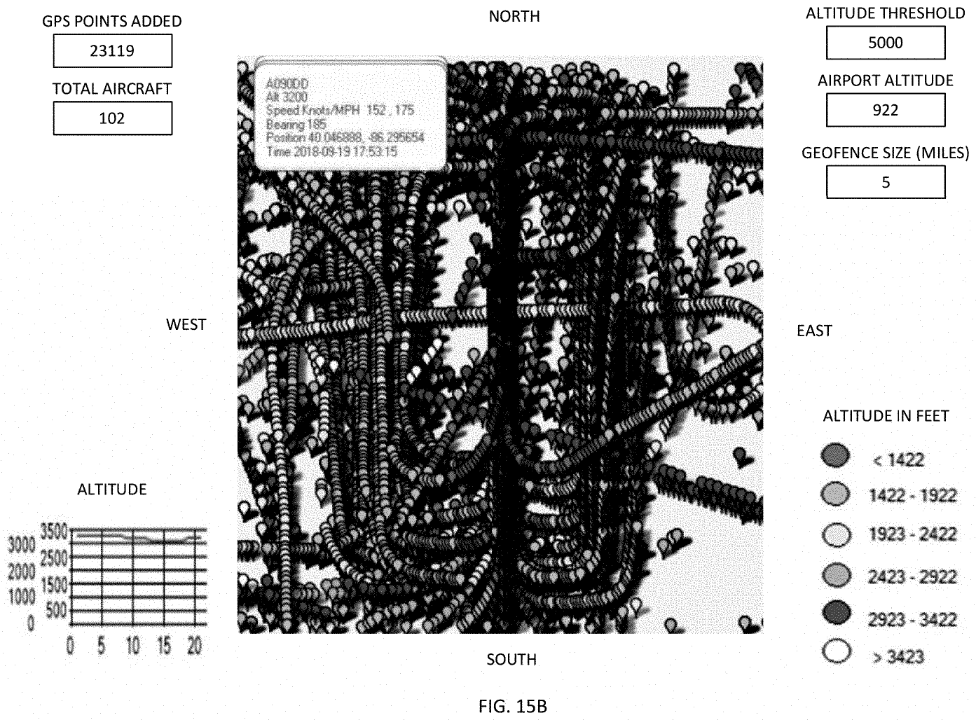

By way of further example of the output reporting of the present invention, FIG. 15 depicts aircraft activity and operations within the geofenced area over an airport, showing aircraft data by the selected parameters shown in FIG. 15A as previously described. Additionally, interactive displays FIGS. 15 and 15B show aircraft ownership information that is selected when the user selects, for example, by mouse click, one of the ADS-B received GPS points. FIG. 15B shows all the ADS-B received GPS and altitudes for all of the planes captured in the polygon for the particular day selected.

The above-described embodiments of the present invention are intended to be examples only. Alterations, modifications and variations may be effected to the particular embodiments by those of skill in the art without departing from the scope of the invention, which is defined solely by the claims appended hereto. The present disclosure provides, generally, computer systems that are programmed to implement the methods and systems described herein. The computer systems include central processing units (e.g., processors), which can be a single core or multi core processor, or a plurality of processors for parallel processing. The computer systems may include memory (e.g., random-access memory, read-only memory, flash memory), electronic storage units (e.g., hard disk, static RAM, memory stick, SDRAM modules), communication interfaces (e.g., network adapters, wireless adapters) for communicating with one or more other systems, and peripheral devices, such as cache, other memory, data storage and/or electronic display adapters.

The memory, storage units, interfaces, and peripheral devices are known to be communications with the CPU processors through communication buses, which may be a motherboard or a backplane of an electronic user device. Storage memory may be a data storage unit or data repository such as an RDMS database for storing data. Computer systems may be operatively coupled to a computer network (“network”) with the aid of a communication interface.

The networks may be the Internet, an internet and/or extranet, Ethernet, WIFI, WLAN, or an intranet and/or extranet in communication with the Internet. The networks may in some cases be a telecommunication and/or data network. The networks can include one or more computer servers, which can enable distributed computing, such as cloud computing. The networks in some cases with the aid of the computer systems may implement a peer-to-peer network, which may enable devices coupled to the computer system to behave as a client or a server computer. Computer systems may communicate with one or more remote computer systems through the network with a remote computer system of a user, such as a user's electronic user device.

Processors of the computer systems of the present invention may execute a sequence of machine-readable instructions, which can be embodied in a program or software. The instructions may be stored in a memory location. The instructions can be directed to the processor, which can subsequently program or otherwise configure the processor to implement methods of the present disclosure. Processors may be part of a circuit, such as an integrated circuit and one or more other components or modules of the computer systems may be included in a circuit, for example, in some cases, the circuits may be an application specific integrated circuit (ASIC). Storage units may store files, such as drivers, libraries and saved programs. Storage units may store user data, e.g., user preferences and user programs. Computer systems may in some cases include one or more additional data storage units that are external to the computer systems, such as located on a remote server that is in communication with the computer systems through an intranet or the Internet or other data communications link.

Methods as described herein may be implemented by way of executable code stored on an electronic storage location of the computer system, such as, for example, on the memory or other electronic storage unit. Machine executable or machine-readable code may be provided in the form of software. During use, the code may be executed by the processor, retrieved from the storage unit and stored on the memory for ready access by the processor. In some situations, machine-executable instructions may be stored directly to memory. Computer codes may be pre-compiled and configured for use with a machine have a processer adapted to execute the code or can be compiled during runtime. The code can be supplied in a programming language that can be selected to enable the code to execute in a pre-compiled or as compiled fashion.

As used herein, unless restricted to non-transitory, tangible “storage” media, terms such as computer or machine “readable medium” refer to any medium that participates in providing instructions to a processor for execution. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system can include or be in communication with an electronic display that comprises a user interface (UI) for providing, for example, user interfaces associated with the connecting over the air radio transmission content to digital devices system. Examples of UI's include, without limitation, a graphical user interface (GUI) and web-based user interface. Methods and systems of the present disclosure can be implemented by way of one or more algorithms. An algorithm can be implemented by way of software upon execution by a CPU/processor.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

1. A system for unattended or non-towered airport management, the system comprising:
a user interface for defining one or more geofenced areas about an airport, each geofenced area denoted by a user-defined virtual boundary defining a mathematically predetermined airspace of horizontal and vertical extent;
a radio device for receiving multiple radio transmissions from one or more radio transmission sources located within the one or more geofenced areas, wherein at least one of the multiple radio transmissions is a radio transmission that includes a unique signature element, the unique signature elements corresponding to aircraft identity data from an Automatic Dependent Surveillance-Broadcast Out (ADS-B Out) equipped aircraft uniquely trackable within the one or more geofenced areas;
a signal interface connected to the radio device, the signal interface including an ADS-B receiver capable of receiving the unique signature element including aircraft identity data from the ADS-B Out equipped aircraft; and
a computing device connected to the signal interface, the computing device generating an output report corresponding to each of the multiple radio transmissions;
wherein the output report indicates operational counts within each of the one or more user-defined geofenced areas based on the aircraft identity data from ADS-B Out equipped aircraft operating within each geofenced area, and
wherein ADS-B Out GPS and altitude information received in the ADS-B Out data is used to exclude from the output report aircraft operations within each user-defined geofenced area about the airport.

2. The system of claim 1, further comprising:
a cloud-based server located at a central location and storing data related to the airport and additional airports, and
an output report generated by the computing device based on accumulated data stored at the cloud-based server, the output report including operational counts within the geofenced area of the airports;
wherein the cloud-based server provides data storage that is located remote from the computing device.

3. The system of claim 1, wherein the one or more user-defined geofenced areas may be configured to report operational counts over multiple days.

4. The system of claim 1, wherein the one or more user-defined virtual boundaries of the geofenced areas may be configured to include two or more polygons configured to report operational counts within the multiple polygons.

5. The system of claim 1, wherein the one or more user-defined geofenced areas may be configured to report operational counts within a three-dimensional polygon at an altitude and location customizable by the user.

6. The system of claim 1, wherein the one or more user-defined geofenced areas may be configured to report operational counts at, above, or below a maximum altitude.

7. The system of claim 1, the one or more user-defined geofenced areas may be defined by four or more points of a two-dimensional or three-dimensional polygon within or in proximity to the airport.

8. The system of claim 1 wherein the audiovisual output and the output report provide voice data information at the airport.

9. The system of claim 1 wherein the output report includes information categorized by one or more of the unique signature elements of more than one airport.

10. The system of claim 1 wherein the output report includes counting and tracking information of the ADS-B Out equipped aircraft within each of the user-defined geofenced areas of more than one airport.

11. A method for unattended or non-towered airport management, comprising:
providing a user interface for defining one or more geofenced area about an airport, each geofenced area denoted by a user-defined virtual boundary defining a mathematically predetermined airspace of horizontal and vertical extent;
receiving, from one or more radio transmission sources located within the geofenced area, radio transmissions from the one or more radio transmission sources located within the one or more geofenced areas, wherein at least one of the multiple radio transmissions is a radio transmission that includes a unique signature element,
the unique signature element corresponding to aircraft identity data from an Automatic Dependent Surveillance-Broadcast Out (ADS-B Out) equipped aircraft uniquely trackable within the one or more geofenced areas;
receiving, at a signal interface connected to the radio device, the unique signature element including the aircraft identity data from one or more ADS-B Out equipped aircraft;
a computing device connected to the signal interface, the computing device generating an output report corresponding to each of the multiple radio transmissions;
wherein the output report includes operational counts within the geofenced area of the airport; and
wherein the output report indicates operational counts within each of the one or more user-defined geofenced areas about the geofenced area of the airport based on the aircraft identity data from ADS-B Out equipped aircraft operating within each geofenced area, and
wherein ADS-B Out GPS and altitude information received in the ADS-B Out data is used to exclude from the output report aircraft operations within each user-defined geofenced area about the airport.

12. The method of claim 11, further comprising:
a cloud-based server located at a central location and storing data related to the airport and additional airports, and
an output report generated by the computing device based on accumulated data stored at the cloud-based server, the output report including operational counts within the geofenced area of the airports;
wherein the cloud-based server provides data storage that is located remote from the computing device.

13. The method of claim 11, wherein the one or more user-defined geofenced areas may be configured to report operational counts over multiple days.

14. The method of claim 11, wherein the one or more user-defined geofenced areas may including two or more polygons configured to report operational counts within the multiple polygons.

15. The method of claim 11, wherein the one or more user-defined geofenced areas may be configured to report operational counts within a three-dimensional polygon at an altitude and location customizable by the user.

16. The method of claim 11, wherein the one or more user-defined geofenced areas may be configured to report operational counts at a maximum altitude.

17. The method of claim 11, the one or more user-defined geofenced areas may be defined by four or more points of a two-dimensional or three-dimensional polygon within or in proximity to the airport.

18. The method of claim 11, wherein the audiovisual output and the output report provide voice data information at the airport.

19. The method of claim 11, wherein the output report includes information categorized by one or more of the unique signature elements of more than one airport.

20. The method of claim 11, wherein the output report includes counting and tracking information of the ADS-B Out equipped aircraft within each of the one or more user-defined geofenced areas of more than one airport
